(19) United States
(12) Patent Application Publication
(10) Pub. No.: US 2011/0280696 A1
(43) Pub. Date: Nov. 17, 2011

(54) Railroad Freight Car Loading Or Unloading

(76) Inventors: David Kun, Federal Way, WA (US); George Chen, Los Gatos, CA (US)

(21) Appl. No.: 12/832,054

(22) Filed: Jul. 7, 2010

Related U.S. Application Data
(63) Continuation-in-part of application No. 12/777,278, filed on May 11, 2010.
Application No. 12/777,278 is a continuation-in-part of application No. 12/779,841, filed on Jul. 7, 2010.

(51) Int. Cl. B61D 47/00; B65G 67/00

(52) U.S. Cl. 414/333; 414/800

(57) ABSTRACT

The present invention discloses an apparatus for transferring freight among different modes of transportation including: a railway spur; zones located in parallel along the railway spur; L-cars located over the railway spur to carry the freight; an external propulsion mechanism located along the railway spur to move the L-cars; sensors and actuators located in the zones to start and stop the L-cars; and connector rails located along the railway spur to direct the L-cars to desired zones.

### CLAIM OF PRIORITY

This is a continuation-in-part application of U.S. patent application Ser. No. 12/777,278 filed on May 11, 2010 and U.S. patent application Ser. No. 12/779,841 filed on Jul. 7, 2010, both of which are currently pending.

### BACKGROUND OF THE INVENTION

1. Field of the Invention

The present invention relates to a field of transportation, and, more specifically, to loading or unloading a railroad freight car.

2. Discussion of Related Art

A load being transported across a region may include freight (or lading). Freight of various sizes, shapes, and weights may be packed and combined in a container or semi-trailer with standard dimensions. The container or semi-trailer permits secure storage and reliable transportation.

Along a journey from one or more origination points to one or more destination points, the container or semi-trailer may be transferred among various modes of transportation. The various modes include by tractor on road, by railroad freight car (or rolling stock) on rail, by cargo ship on river, lake, or ocean, or by cargo airplane in air.

The present invention discloses a method of and an apparatus for loading or unloading a railroad freight car.

### SUMMARY OF THE PRESENT INVENTION

Accordingly, an object of the present invention is to transfer a container or semi-trailer between various modes of transportation with an L-car of the present invention on a railway spur.

Another object of the present invention is to propel the L-car of the present invention from overhead or below.

Still another object of the present invention is to tilt a deck of an L-car of the present invention with a landing gear or a jack.

Yet another object of the present invention is to load or unload a container or semi-trailer being transported on an L-car of the present invention.

The foregoing and other objects of the present invention may be accomplished with an L-car of the present invention that may include a deck, a dolly attached to a rear section of the deck, a landing gear attached to a mid-section of the deck, and a jack attached to a front section of the deck.

The foregoing and other objects of the present invention may be achieved with a system of the present invention that may include a mechanism to operate a landing gear of an L-car.

The system of the present invention will be more completely understood from the following detailed description of the present invention taken in conjunction with the drawings and the claims.

### BRIEF DESCRIPTION OF THE DRAWINGS

FIG. 1 shows a schematic overhead view of railway spur to transfer a container or semi-trailer according to an embodiment of the present invention.

FIG. 2 shows a schematic elevation view of L-cars assembled in a string in a train according to an embodiment of the present invention.

FIG. 3A shows a schematic elevation view of an L-car with an overhead external propulsion mechanism according to an embodiment of the present invention.

FIG. 3B shows a schematic elevation view of an L-car with an underlying external propulsion mechanism according to an embodiment of the present invention.

FIGS. 4A-4C show a schematic elevation view of a sensor and an actuator to stop and start the L-car according to an embodiment of the present invention.

### DETAILED DESCRIPTION OF THE PRESENT INVENTION

In the following description, numerous details, examples, and embodiments are set forth to provide a thorough understanding of the present invention. However, it will become clear and apparent to one of ordinary skill in the art that the invention is not limited to the details, examples, and embodiments set forth and that the invention may be practiced without some of the particular details, examples, and embodiments that are described. In other instances, one of ordinary skill in the art will realize that certain details, examples, and embodiments that may be well known have not been specifically described so as to avoid obscuring the present invention.

The present invention envisions an apparatus for and a method of transferring freight among different modes of transportation.

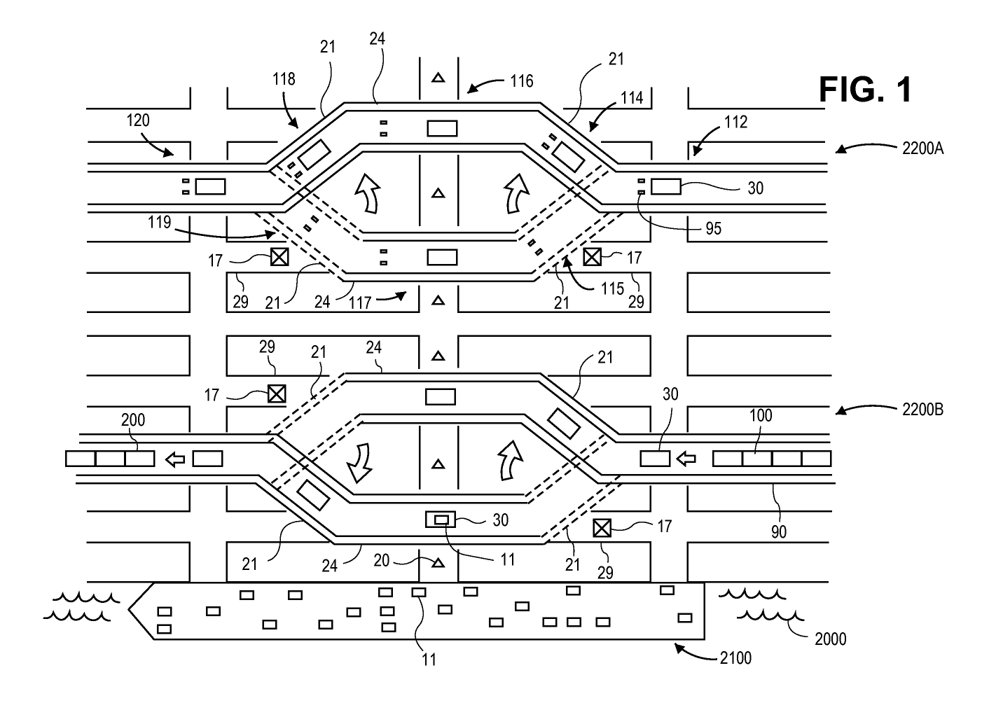

As shown in FIG. 1 a combination of the freight (or lading) having various sizes, shapes, and weights may be initially stored in a container or semi-trailer 11. To reduce space (footprint) in a first mode of transportation, the container may be stacked vertically over another container. However, the semi-trailer 11 is usually not stacked vertically.

In most cases, the container or semi-trailer 11 has external dimensions that have been standardized by organizations such as the International Standards Association (ISO). Typical lengths of the container may include 20, 40, 45, 48, and 53 feet. Typical widths of the container may include 8 and 8.5 feet. Typical heights of the container may include 4.25 (or half height), 8, 8.5, 9.5, and 10.5 feet. Depending on the type and quantity of freight being transported, typical weights of the container may be 40,000-75,000 pounds when fully loaded.

To permit mobility, the container may be unstacked and placed on a chassis with 2 axles, such as with a total of 4 wheels (usually located near and below the 4 corners of the container) so as to roll on a road 29. The semi-trailer 11 already has mobility because it includes 2 axles near the rear. In one case, each axle may have a pair of double wheels (or dualies) near each end of the axle so as to roll on the road 29.

Subsequently, at a transfer location between two modes of transportation, the container or semi-trailer 11 may be moved over to an intermediate mode of transportation, such as an L-car 30 of the present invention. Then, the freight may be moved again to a second mode of transportation. For example, the container (on the chassis with wheels) or the semi-trailer 11 (with the rear wheels) may be pulled off the L-car 30 by a tractor 17 and transported on the road 29 to one or more destination points.

According to an embodiment of the present invention as shown in FIG. 1, the apparatus for and the method of transferring freight between a first mode of transportation (such as a cargo ship 2100 on a body of water, such as a river, a lake, or an ocean, 2000) and a second mode of transportation (such as the tractor 17 on the road 29) may include an intermediate mode of transportation, such as an L-car 30 of the present invention.

In an embodiment of the present invention as shown in FIG. 1, the intermediate mode of transportation may include the railway freight car, such as the L-car 30 disclosed in the present invention, traveling over one or more railway spurs 2200A, 2200B. In one case, the track for the railway spur 2200A, 2200B includes 2 rails separated by a track gauge, such as 56.5 inches.

The L-car 30 disclosed in the present invention may include a length selected from a range of 70-90 feet. In most cases, the L-car 30 may include a width selected from a range of 9-11 feet. When consecutive L-cars are connected together, a deck 36 of the L-car 30 may be tilted, such as upwards (from rear to front of the deck 36) at a positive angle. Typically, various sections of the deck 36 of the L-car 30 may be located a distance, or height, of between 0.5 and 4.5 feet above the rail 13.

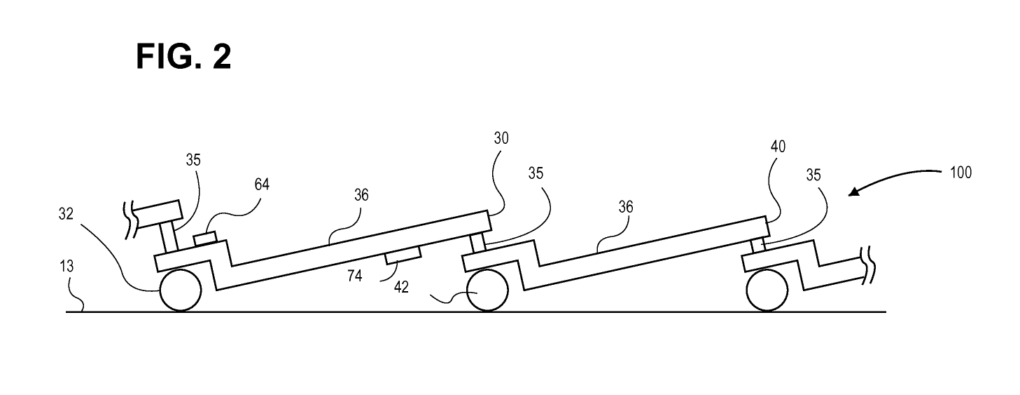

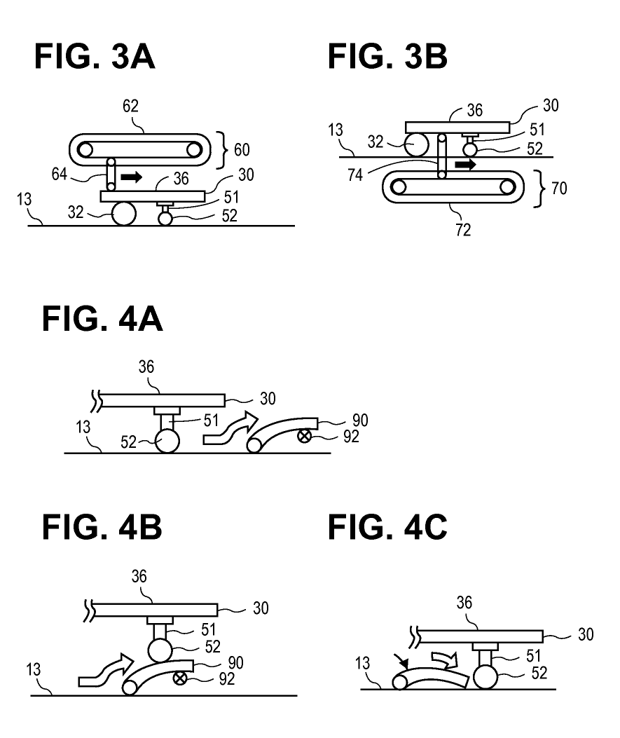

A large number, such as 75-225, of railway freight cars, such as L-cars 30, may be coupled together in a string 100 in an arriving or coming train as shown in FIG. 2. The dolly 32 (near the rear section) of the L-car 30 rests and travels over rail 13 while the fixture 35 (near the front section) of the L-car 30 swivels and mounts above the (rear) dolly 42 of another L-car 40 (located in front). The L-car 30 may further include a structural member having a certain geometry, shape, size, and dimension, such as a hinged rod or arm 64 and a hinged cross-piece 74 to attach to an external propulsion mechanism which can move, such as push or pull, the L-car 30 on the rail 13 without a locomotive. The structural members 64, 74 are shown in a stowed or retracted mode in FIG. 2 and in a deployed or extended mode in FIGS. 3A-3B.

A grid of sensors 95, located along the railway spur 2200A, 2200B, may work in conjunction with a grid of actuators, also located along the railway spur 2200A, 2200B, to align and position the L-car 30 with sufficient precision in various sectors or zones. The sensors 95 may be used in pairs, as shown in FIG. 1, or singly.

The sensors 95 may be contact, inductive, or capacitive. The actuators may be pneumatic, hydraulic, or motorized. A grid of switches, such as limit switches, may also be located between the sectors or zones. The switches may be mechanical, electro-optical, or magnetic. The switches may be controlled by one or more computers. The computers may be standalone, localized, centralized, remote, or in a cloud.

After the coming train arrives over the railway spur, such as 2200B, the L-cars 30 in the string 100 may optionally be separated nearby into a cluster of L-cars in a buffer location. In one case, the cluster of L-cars 30 may move passively (without power), at least initially, such as down a slope, towards a staging location 112.

Subsequently, the L-cars 30 may be separated individually and moved closer into a vicinity of the cargo ship 2100 for loading or unloading (or, if desired, for bypassing). In one case, the L-car 30 may move actively (with power), such as with an external propulsion mechanism, to one or more other sectors or zones along the railway spur 2200A, 2200B. The external propulsion mechanism may be located below, above, or adjacent to the railway spur 2200A, 2200B.

The external propulsion mechanism may include a series of connection devices integrated with adjustment devices, control devices, and power devices. The connection devices are closed-circuit or endless and may include belts, cables, or chains, The adjustment devices are active and may include springs, tensioners, pulleys, cams, gear trains, and drive shafts. In one case, the control devices are passive and may include rails, pins, or rollers, such as to support, align, or guide the belts, cables, or chains. In another case, the control devices are passive and may include grooves or channels, such as to support, align, or guide the belts, cables, or chains. The power devices may include electric motors, with back-up or fail-safe systems, to drive the belts, cables, or chains, in closed circuit, such as at a desired speed.

The L-car 30 may include one or more attachment devices, such as clamps or jaws. As desired, the attachment device progressively engages, such as grips, the driven endless belts, cables, or chains in order to couple, synchronize, and propel the L-car 30. Alternatively, the attachment device progressively disengages, such as releases, the driven endless belts, cables, or chains in order to decouple the L-car 30. Then, one or more brakes may be applied to one or more wheels in the dolly to stop the L-car 30 even as the endless belts, cables, or chains continue to be driven in closed circuit, such as at a constant speed, by the power devices.

As desired, the railway spur 2200A, 2200B may be divided into sectors or zones. For example, staging location 112 is a shared entry (arriving or coming) zone, locations 116, 117 are distinct loading or unloading zones (such as called “A” 116 and “B” 117), and location 120 is a shared exit (departing or going) zone. In one embodiment of the present invention, a first set of switches directs the L-car 30 upon entry, to shunt location 114 or 115. In another embodiment of the present invention, a second set of switches directs the L-car 30 upon exit, to shunt location 118 or 117. Then the L-cars 30 may be connected into clusters and then into the string 200 of the train on the departing or going track.

A first set of zones may be arranged in parallel while a second set of zones may be arranged in series. The distinct loading or unloading zones (such as called “A” 116 and “B” 117) are examples of the first set of zones that are arranged in parallel. The shared entry (arriving or coming) zone 112 and the shared exit (departing or going) zone 120 are examples of the second set of zones that are arranged in series.

The zones with their corresponding locations and functions may be designated in a layout. As desired, the layout may be optimized. In one case, the layout may be standardized. In another case, the layout may be customized. Customization of the layout may be implemented as desired, such as by type of use, owner of container, or owner of freight. The customization may be performed by using only hardware, only software, or a combination of hardware and software.

Various configurations may be contemplated according to the present invention. In one configuration, as shown on railway spur 2200A in FIG. 1, the first and second set of switches are selected to permit one or more higher priority L-cars 30 (or hotshots) to arrive (load) and depart (unload) by moving sequentially through locations 112, 114, 116, 118, and 120 while one or more other lower priority L-cars may be waiting their turn at locations 115, 117, and 119.

Such a configuration permits unequal priority L-cars to load or unload, such as with a last-in-first-out (LIFO) logic. For example, higher priority L-cars that arrive later may be permitted to overtake (move ahead of) lower priority L-cars that arrive earlier.

Such a configuration also permits L-cars (that do not need to load or unload) to bypass other L-cars (that do need to load or unload). Frequency of switching is reduced which may be desirable, but efficiency may become lower which may not be desirable.

In another configuration, as shown on railway spur 2200B in FIG. 1, the first and second set of switches are selected to permit one or more L-cars 30 to arrive (load) by moving through locations 112, 114, and 116 while concurrently permitting one or more other L-cars to depart (unload) by moving through locations 117, 119, and 120.

Such a configuration permits equal priority L-cars to load or unload, such as with a first-in-first-out (FIFO) logic. Frequency of switching is increased which may not be desirable, but efficiency may become higher which may be desirable.

For both configurations described above, the container may be removed from the first mode of transportation, such as the cargo ship 2100, with a lifting mechanism, such as an overhead or gantry crane, 20 and placed on the chassis already sitting on the L-car 30, at loading location 116, 117, along the railway spur 2200A. In another case, the semi-trailer 11 is lifted off the cargo ship 2100 with the overhead or gantry crane 20 and placed directly on the L-car 30, at location 116, 117, along the railway spur 2200A.

Next, certain exemplary embodiments of the method and the apparatus disclosed by the present invention will be described in greater detail. However, other embodiments also claimed in the present invention will not be specifically described.

As shown in FIG. 1, an arriving or coming track, such as from a higher elevation, may become full of L-cars 30 assembled in a string 100 in a train. The string 100 in the train may optionally roll down a slope on the coming track.

While assembled in the string 100 in the train as shown in FIG. 2, a dolly 32 in a rear of the L-car 30 may ride on a rail 13 of the track. A landing gear of the L-car 30 may be stowed, such as folded or retracted inside a cavity with a hatch or cover. The landing gear of the L-car 30 may include 2 legs connected with an axle. Each leg may have a small wheel.

Next, a cluster of L-cars 30, such as 5 L-cars 30, may be separated from the string 10 in the train. The landing gear of the lead L-car 30 may now be deployed, such as unfolded or extended. When the landing gear is deployed, the small wheel of the leg may now also ride on the rail 13 of the track. Thus, the stand-alone L-car 30 may ride on the rail 13 with both the rear dolly 32 and the landing gear.

As shown in FIG. 3A, a hinged rod or arm 64 may be deployed from the deck 36, such as near and above the rear section, of the L-car 30. An external propulsion mechanism, such as a power wincher, 60 may be located overhead above the L-car 30 riding on the rail 13. The power wincher 60 may engage the extended arm 64 and may move the L-car 30 and the other L-cars connected in the same cluster forwards along the rail 13. The cluster may be separated into individual L-cars 30 in a staging area.

As shown in FIG. 3B, a hinged cross-piece 74 may be deployed from the deck 36, such as near and below the mid-section of the L-car 30. The cross-piece 74 may be attached between the 2 legs of the landing gear of the L-car 30. The cross-piece 74 may have a hook. An external propulsion mechanism, such as a conveyor belt, 70 may be located below the L-car 13 riding on the rail 13. The conveyor belt, 70 may be located below a floor of the track. The conveyor belt 70 may include a V-shaped puller structure to catch the hook of the cross-piece 74. Then, the conveyor belt 70 may take over from the power wincher 60 in the staging area and may pull the L-car 30 to an entry zone 112.

As shown in FIG. 4A, an axle-rest arm structure 90 may serve as both a sensor and an actuator. The axle-rest arm structure 90 may protrude slightly above the rail 13 at the entry zone 112. When the L-car reaches the entry zone 112, the cross-piece 74 may slide and climb up the axle-rest arm structure 90. As a result, the hook of the cross-piece 74 becomes disengaged from the V-shaped puller structure of the underlying conveyor belt 70, thus stopping the L-car 30 and allowing the cross-piece 74 to come to a rest on top of the axle-rest arm structure 90.

One of the loading or unloading zones (such as called “A” 116 or “B” 117) shown in FIG. 1 may be selected. Then, portable structural members, such as connector rails, 21 may be shifted to connect to the selected loading or unloading zone. In order to shift the connector rails 21, various sequences of one or more other operations, such as removing, lifting, pivoting, replacing, and leveling, may be needed. In one case, the connector rails 21 may be located over a platform, such as formed from concrete. In another case, a ramp may be located adjacent to the connector rails 21 for use in subsequently loading or unloading the L-car 30.

The connector rails 21 may be straight or curved. The connector rails 21 may be rigid or flexible. The connector rails 21 may be jointed, articulated, or hinged. In one case, the connector rails 21 may have a short length and a light weight so that the shifting may be accomplished manually, such as by pulling on a chain and a hook.

After the connector rails 21 have been shifted into place, an electric screw motor may withdraw a release pin 92. A spring helps the axle-rest arm structure 90 to lean forward. The cross-piece 74 slides and climbs down the top of the axle-rest arm structure 90. Upon re-catching the hook on the V-shaped puller structure, the conveyor belt 70 resumes pulling the L-car 30 forward.

In this way, the L-car 30 may travel over the connector rail 21 to the selected loading or unloading zone (such as called “A” 116 or “B” 117) as shown in FIG. 1.

When the L-car 30 reaches the selected loading zone, the cross-piece 74 again pushes up another axle-rest arm structure 90 that is located above the rail 13 and comes to a rest on top of the axle-rest arm structure 90, thus un-catching the hook from the V-shaped puller structure to stop the L-car 30. The axle-rest arm structure 90 is supported in a raised position by the release pin 92.

Next, a container from the cargo ship may be brought down by the overhead or gantry crane 20 and placed directly on the chassis that has already been pre-loaded on the deck 36 of the L-car 30. The chassis may have 2 sets of wheels.

Then, other connector rails 21 may be shifted, such as to connect to the unloading zone, such as the road 29. The electric screw motor withdraws the release pin 92 so that the spring can help the axle-rest arm structure 90 lean forward, letting the cross-piece 74 fall off the top of the axle-rest arm structure 90, thus re-catching the hook on the V-shaped puller structure on the conveyor belt 70 to again pull the L-car 30 forward. The L-car 30 is pulled onto the connector rails 21 to the unloading zone.

The container may be unloaded from the L-car 30 in the unloading zone. The legs of the landing gear are stowed, such as by folding under the deck 36, such as with a hand crank, to tilt the deck forward. When the deck 36 is lowered near a top of the rail 13, the tractor 17 may be backed up to pull the container, on the chassis, off the L-car 30.

Next, the legs of the landing gear are deployed, such as by unfolding from under the deck 36, such as with the hand crank to raise and support the deck again. Then, the L-car 30 leaves on a departure or going track. The L-car 30 rides on the rail 13 of the departure or going track with a rear dolly 32 and with 2 legs having an axle with small wheels and a center-piece 74. The L-car 30 may be assembled initially into a cluster, such as of 5 L-cars 30. Then, the L-cars 30 in the cluster may be further assembled into the string 200 in the train on the departure or going track.

Meanwhile, the tractor 17 may back up on the road 29 that is adjacent to the loading or unloading zone (such as called “A” 116 or “B” 117). The deck of the L-car 30 may first be tilted forwards and downwards by 10-30 degrees. Then, the tractor 17 may connect to the container, such as on the chassis, or the semi-trailer 11. The connection between the tractor 17 and the container, such as on the chassis, or the semi-trailer 11 may include the same fixture 35 that may connect two consecutive L-cars 30 as shown in FIG. 2. Then, the tractor 17 may transfer, such as by pulling, the container, such as on the chassis, or the semi-trailer 11 off the free-standing, or parked, L-car 30 onto the adjacent road 29.

In some cases, the semi-trailer 11 may be short (called a pup), such as 24, 28.5 feet. In other cases, the semi-trailer 11 may be long, such as 40, 48, 50, 53 feet. Depending on the type of freight being transported, typical weights of the semi-trailers 11 may be 35,000-100,000 pounds when fully loaded.

Guidelines issued by the Department of Transportation (DOT) may specify that the container or semi-trailer 11 being pulled by a tractor 17 on a road 29, such as an interstate highway in the United States, may not exceed a length of 85-89 feet, a width of 8.5 feet, a height of 13.5 feet, and a gross weight of 80,000 pounds.

A long combination vehicle (or LCV) may include the tractor 17 pulling 2 semi-trailers 11 (or doubles) or 3 semi-trailers 11 (or triples). In one case, the gross weight limit may be increased to 129,000 pounds for a combination of 3 short semi-trailers 11 or for a combination of 1 long semi-trailer 11 and 1 short semi-trailer 11. In another case, the gross weight limit may be increased to 147,000 pounds for a combination of 2 long semi-trailers 11.

Under certain situations, a state may promulgate local rules for the vehicles that travel over the roads 29 in that particular state. The state may issue a permit, which may be temporary, for a vehicle that exceeds a size limit or a weight limit. However, the permit may require that the vehicle travel along a certain road 29 or travel at a certain time of the day or on a certain day of the week.

Subsequently, the tractor-trailer (a combination of the tractor 17 and the unloaded container, such as on the chassis, or the semi-trailer 11) may continue its journey on the road 29. The trip of the tractor-trailer to one or more destination points may include various distances, such as 3,000 miles. However, a typical distance may be less than 500 miles when efficiency is balanced against flexibility.

Many embodiments and numerous details have been set forth above in order to provide a thorough understanding of the present invention. One skilled in the art will appreciate that many of the features in one embodiment are equally applicable to other embodiments. One skilled in the art will also appreciate an ability to make various equivalent substitutions for those specific materials, processes, dimensions, concentrations, etc. described herein. It is to be understood that the detailed description of the present invention should be taken as illustrative and not limiting, wherein the scope of the present invention should be determined by the claims that follow.

We claim:

1. An apparatus for transferring freight among different modes of transportation comprising:
a railway spur;
zones disposed in parallel along said railway spur;
L-cars disposed over said railway spur to carry said freight;
an external propulsion mechanism disposed along said railway spur to move said L-cars;
sensors and actuators disposed in said zones to start and stop said L-cars; and
connector rails disposed along said railway spur to direct said L-cars to desired zones.

2. The apparatus of claim 1 wherein said zones comprise a first set of zones disposed in parallel along said railway spur.

3. The apparatus of claim 2 wherein said first set of zones comprise distinct loading or unloading zones.

4. The apparatus of claim 1 wherein said zones comprise a second set of zones disposed in series along said railway spur.

5. The apparatus of claim 4 wherein said second set of zones comprise shared entry zone and shared exit zone.

6. The apparatus of claim 1 wherein said L-cars comprises a deck, a dolly, a landing gear, and a jack.

7. The apparatus of claim 1 wherein said external propulsion mechanism is disposed below said L-cars.

8. The apparatus of claim 1 wherein said external propulsion mechanism comprises chains, pulleys, gears, and wheels.

9. The apparatus of claim 1 wherein said L-cars further comprise a clamping device and brakes.

10. The apparatus of claim 1 further comprising a computer to control said switches and said propulsion mechanism.

11. An apparatus for transferring a container or semi-trailer comprising:
a railway spur;
an L-car disposed on said railway spur, said L-car comprising:
a deck to carry said container or semi-trailer;
a dolly disposed below a rear section of said deck;
a landing gear disposed below a mid-section of said deck; and
a jack disposed below a front section of said deck; and
a tractor disposed on a road adjacent to said railway spur.

12. The apparatus of claim 9 wherein said landing gear of said L-car comprises axially telescoping legs.

13. The apparatus of claim 9 wherein said landing gear of said L-car comprises laterally bending legs.

14. The apparatus of claim 9 wherein said landing gear of said L-car comprises wheels.

15. The apparatus of claim 9 further comprising a hinge disposed at a mid-section of said deck of said L-car.

16. A method of transferring a container comprising:
separating an L-car from a first string of L-cars on an arriving track;
moving said L-car along a railway spur to an entry zone;
stopping said L-car at said entry zone;
switching said L-car to an entry shunt zone;
moving said L-car along said railway spur to a loading zone;
loading a container onto said L-car;
switching said L-car to an exit shunt zone;
moving said L-car along said railway spur to an unloading zone;
unloading said container from said L-car; and
assembling said L-car into a second string of L-cars on a departing track.

17. The method of claim 16 wherein said moving along said railway spur to said entry zone results from a slope along said railway spur.

18. The method of claim 16 wherein said moving along said railway spur to a loading zone is performed by an external propulsion mechanism.

19. The method of claim 16 wherein said stopping is performed by sensors and actuators disposed along said railway spur.

20. The method of claim 16 wherein unloading said container from said L-car comprises tilting a deck of said L-car and pulling said container off said deck.
